(19) United States
(12) Patent Application Publication
(10) Pub. No.: US 2012/0166558 A1
(43) Pub. Date: Jun. 28, 2012

(54) APPARATUS AND METHOD FOR FORWARDING EMAIL

(75) Inventors: Eun-Joo KIM, Seoul (KR); Soon-Seok Lee, Daejeon-si (KR); Young-Boo Kim, Gongju-si (KR)

(73) Assignee: Electronics and Telecommunications Research Institute, Daejeon (KR)

(21) Appl. No.: 13/333,446

(22) Filed: Dec. 21, 2011

(30) Foreign Application Priority Data
Dec. 22, 2010 (KR) 10-2010-0132419

(51) Int. Cl. G06F 15/16

(52) U.S. Cl. 709/206

(57) ABSTRACT

An email forwarding apparatus and method are provided. The email forwarding apparatus for an original email received from a transmitter email providing apparatus to a mobile communication terminal device in response to a request from the transmitter email providing apparatus, the email forwarding apparatus includes a data communication unit to transmit and receive information regarding an email to and from the transmitter email providing apparatus or the mobile communication terminal device; a file storage unit to store an attachment file that is attached to the original email; and a control unit to transmit to the mobile communication terminal device an email which includes access information associated with the attachment file stored in the file storage unit and/or text information contained in the original email and transmit to a receiver email providing apparatus a forwarding email which includes the attachment file stored in the file storage unit and/or remade text information.

### CROSS-REFERENCE TO RELATED APPLICATION(S)

This application claims the benefit under 35 U.S.C. §119(a) of Korean Patent Application No. 10-2011-0132419, filed on Dec. 22, 2010, in the Korean Intellectual Property Office, the entire disclosure of which is incorporated herein by reference for all purposes.

### BACKGROUND

1. Field

The following description relates to email transmission, and more particularly, to an email service apparatus and method capable of forwarding an email with an attached file.

2. Description of the Related Art

With the development of network technology and the spread of multimedia services, transmission and reception of large-scale files increasingly occur between transmitters and receivers of computers or mobile communication terminals. In an electronic mail system, in which an electronic mail (email) has a file attached for delivery to a receiver, an email server itself regulates the size of the email to be delivered, and thus it may be difficult to transmit a large-scale file to a computer or a mobile communication terminal of the receiver.

To overcome such drawbacks, a conventional electronic mail system has introduced a method of only transmitting a reference related to an attachment file without transmitting the entire file in response to a user's request. In this case, a receiver email server does not need to read the whole of the file received from a transmitter email server. In addition, an unnecessary channel bandwidth occupancy which may occur due to transfer of the attachment file over a network can be reduced when a receiver does not receive the attachment file sent from a transmitter.

In response to a request for attaching a large-scale file from a transmitter, the transmitter email server stores the file in a web-server as large-scale file storage, and only provides the receiver with link information for accessing the large-scale file. Hence, the receiver accesses the web-server via the link information to download the large-scale file. However, the conventional method may have security issues since anyone who obtains the link information can access the web-server and download the file.

On the other hand, in another conventional method, an email server stores a large-scale file therein and provides a mobile communication terminal of a receiver with a file receipt notification message and link information associated with the stored file in response to a request for transmitting the large-scale file from a transmitter. A receiver checks the file receipt notification message through his/her mobile communication terminal and clicks the link information to download the large-scale file from the email server. In this method, because the receiver downloads the large-scale file from the email server to the mobile communication terminal based on his/her decision, unnecessary bandwidth use which may occur due to transfer of the file between the mobile communication terminal and a base station can be reduced.

However, if the receiver forwards the email, an amount of data that is more than twice of the large-scale file is used regardless of receiving the large-scale file from the server, and thus the receiver has to pay a fee for channels that are used more than required for a service actually provided.

In particular, in terms of a mobile communication terminal suitable for WiBro communications with a limitation in channel bandwidth between a base station and the mobile communication terminal, unnecessary channel bandwidth occupancy needs to be reduced.

### SUMMARY

The following description relates to an email forwarding apparatus that forwards an email having a file attached to a receiver terminal device wherein the email is originally transmitted to the mobile communication terminal device.

Furthermore, the following description relates to an email forwarding apparatus and method to minimize channel bandwidth occupancy between a mobile communication terminal device and a base station, thereby reducing line-use fees incurred by data communication.

In one general aspect, there is provided an email forwarding apparatus for an original email received from a transmitter email providing apparatus to a mobile communication terminal device in response to a request from the transmitter email providing apparatus, the email forwarding apparatus including: a data communication unit configured to transmit and receive information regarding an email to and from the transmitter email providing apparatus or the mobile communication terminal device; a file storage unit configured to store an attachment file that is attached to the original email; and a control unit configured to transmit to the mobile communication terminal device an email which includes access information associated with the attachment file stored in the file storage unit and/or text information contained in the original email and transmit to a receiver email providing apparatus a forwarding email which includes the attachment file stored in the file storage unit and/or remade text information.

The control unit may be further configured to include a email notification unit configured to transmit to the mobile communication terminal device email receipt notification that contains access information associated with the attachment file and/or the text information contained in the original email according to the presence of the attachment file in the original email received through the data communication unit, a file storage processing unit configured to store the attachment file attached to the original email in the file storage unit according to the presence of the attachment file in the original email that is determined by the email notification unit, and an email transmitting unit configured to transmit the attachment file to the mobile communication terminal device or forward the attachment file and/or the remade text information to the receiver email providing unit in response to email request information from the mobile communication terminal device.

The email transmitting unit may be further configured to include an email request information check unit configured to check whether the email request information is email receipt request information or email forwarding request information according to the presence of FWD_file instruction information for email forwarding in the email request information, and an original email transmitting unit configured to determine the email request information as email receipt request information if the email request information check unit determines that there is no FWD_file instruction information in the email request information, acquire from the file storage unit the attachment file associated with access information that is included in the email receipt request information and transmit the acquired attachment file to mobile communication terminal device.

The email forwarding request information may include the FWD_file instruction information for email forwarding, remade text information, and/or access information associated with the attachment file.

The email transmitting unit is further configured to further comprise an email forwarding unit configured to, when it is determined that the FWD_file instruction information is included in the email request information, transmit the forwarding email that includes an attachment file associated with the access information and/or remade text information according to the presence of the access information in the email forwarding request information.

Other features and aspects may be apparent from the following detailed description, the drawings, and the claims.

### BRIEF DESCRIPTION OF THE DRAWINGS

FIG. 1 is a diagram illustrating an example of a transmission path for forwarding an email in an email transfer system.

FIG. 2 is a diagram illustrating an example of an email forwarding apparatus.

FIG. 3 is a flowchart depicting an example of a method of an email forwarding apparatus to forward an original email received from a transmitter email providing apparatus to a receiver email providing apparatus.

FIG. 4 is a flowchart depicting an example of a method for the email forwarding apparatus to forward a receipt email to the mobile communication terminal device.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Prior to describing an exemplary embodiment of the present invention, a conventional method of forwarding an email in a general email transfer system will be mentioned.

In a conventional email transfer system, a transmitter email providing apparatus connected to a receiver terminal device and an email forwarding apparatus that receives an original email from the transmitter email providing apparatus and delivers the received email to a mobile communication terminal device. More specifically, in response to a request from a transmitter, a transmitter terminal device uploads a file to be transmitted on the transmitter email providing apparatus connected to the transmitter terminal device in an effort to transmit an email with the file attached to the mobile communication terminal device. Accordingly, the transmitter email providing apparatus stores the uploaded file and transmits the original email having the attached file to the email forwarding apparatus that is connected to the mobile communication terminal device.

In response to the reception of the original email from the transmitter email providing apparatus, the email forwarding apparatus checks whether or not the original email has a file attached thereto, and if the file is attached to the original email, extracts from the original email the attachment file and text information made by the transmitter. Thereafter, the email forwarding apparatus stores the extracted attachment file, and transmits to the mobile communication terminal device an email containing access information associated with the stored attachment file and the text information made by the transmitter. Then, an email receiver confirms that his/her mobile communication terminal device has received the email, and determines whether to download the file attached to the email. According to the email receiver's decision, the mobile communication terminal device transmits attachment file download request information to the email forwarding apparatus. In response to the request, the email forwarding apparatus forwards to the mobile communication terminal device the previously stored attachment file using the access information that is contained in the attachment file download request information. Hence, the email receiver is allowed to view the attachment file downloaded to the mobile communication terminal device.

On the other hand, in a case where the received email is forwarded to another email receiver in response to a request from the email receiver, the mobile communication terminal device may check whether or not the attachment file attached to the email to be forwarded to the other email receiver has been downloaded and stored from the email forwarding apparatus. If the attachment file has not been stored in the email to be forwarded, the mobile communication terminal device downloads the attachment file from the email forwarding apparatus, and transmits a forwarding email that contains the downloaded attachment file and remade text information to the email forwarding apparatus. Thus, the email forwarding apparatus transmits the forwarding email that contains the attachment file and the remade text information to a receiver email providing apparatus that is connected to the other receiver terminal device. The receiver email providing apparatus transmits the forwarding email received from the email forwarding apparatus to the other receiver terminal device.

As such, in the conventional email transfer system, in forwarding an email received by one email receiver to another email receiver, a mobile communication terminal device of the email receiver downloads an attachment file stored in an email forwarding apparatus, and uploads the downloaded attachment file again to the email forwarding apparatus. Accordingly, the email forwarding apparatus is allowed to forward the email that has been transmitted to the mobile communication terminal device to a receiver email providing apparatus. That is, when the email is forwarded without having opened the attachment file, the mobile communication terminal device is required to download the attachment file from the email forwarding apparatus, and thus an actually used amount of data is doubled than the attachment file size, and thus the email receiver that requests forwarding has to pay a fee for channels that are used more than required for a service actually provided. Hereinafter, a method of forwarding an email in an email transfer system according to an exemplary embodiment of the present invention will be described in detail.

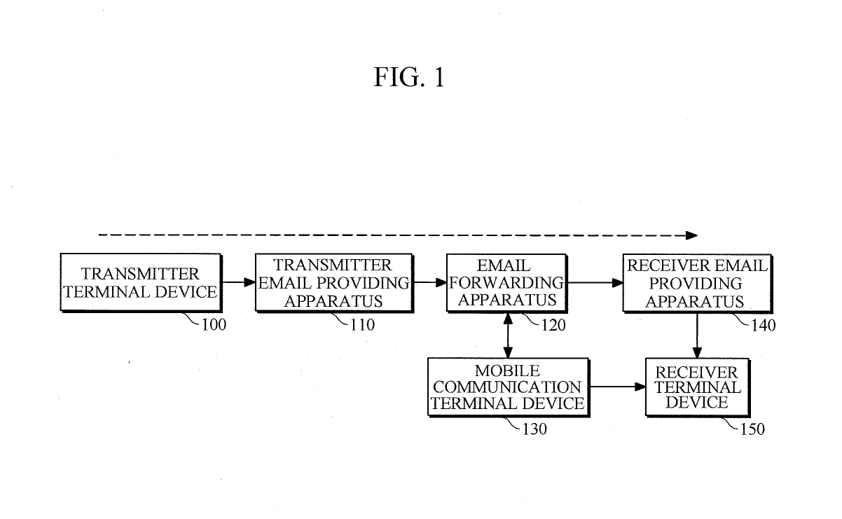

FIG. 1 illustrates a diagram of an example of a transmission path for forwarding an email in an email transfer system.

As shown in the example illustrated in FIG. 1, in response to a request from a transmitter, a transmitter terminal device 100 may transmit an original email having an attachment file attached to a receiver email providing apparatus 110 that is connected to the transmitter terminal device 100. The transmitter email providing apparatus 110 may store the attachment file attached to the original email received from the transmitter terminal device 100, and at the same time transmit the original email with the attachment file to an email forwarding apparatus 120. Here, the transmitter terminal device 100 and the email providing apparatus 120 may transmit the original email or forward a forwarding email with an attachment file according to general simple mail transfer protocol (SMTP).

On the other hand, in response to the reception of the original email from the transmitter email providing apparatus 110, the email forwarding apparatus 120 may check whether the received original email has the attachment file attached, and if there is the attachment file, store the attachment file. Then, the email forwarding apparatus 120 may transmit an email including access information associated with the stored attachment file and text information that has been included in the original email to a mobile communication terminal device 130. More specifically, the email forwarding apparatus 120 may receive the original email from the transmitter email providing apparatus 110, and check whether the received email has the attachment file attached or not. If the original email has the attachment file, the email forwarding apparatus 120 may extract the attachment file and the text information, and store the attachment file. Then, the email forwarding apparatus 120 may transmit an email including the access information associated with the stored attachment file and the text information to the mobile communication terminal device 130. In contrast, if the received original email does not have the attachment file, the email forwarding apparatus 120 may transmit an email containing the text information that has been included in the received original email to the mobile communication terminal device 120.

As a result, the mobile communication terminal device 130 is enabled to output to a display the email which contains both the text information and the access information associated with the attachment file or which only contains the text information received from the email forwarding apparatus 120. When the received email contains the text information and the access information associated with the attachment file, the mobile communication terminal device 130 may be enabled to download the attachment file from the email forwarding apparatus 120 based on the access information in response to a request of a user of the mobile communication terminal device 130.

In addition, the mobile communication terminal device 130 may request forwarding of the email to a receiver terminal device 150 according to a request from the user of the mobile communication terminal device 130. More specifically, once the mobile communication terminal device 130 receives the original email containing both the access information and the text information or the original email only containing the text message, an email which includes remade text information and access information or which only includes remade text information may be forwarded to the receiver terminal device 150.

Specifically, the mobile communication terminal device 130 may transmit to the email forwarding apparatus 120 an email forwarding request information that includes remade text information or both the remade text information and access information. Through instruction information contained in the email forwarding request information, the email forwarding apparatus 120 can identify that the received request is for forwarding the email to the receiver email providing apparatus 140. In this regard, the mobile communication terminal device 130 may transmit the email forwarding request information that includes FWD_file instruction information, the access information associated with the attachment file stored in the email forwarding apparatus 120 and/or the remade test information to the email forwarding apparatus 120. In this case, the mobile communication terminal device 130 may transmit the email forwarding request information according to propriety protocol (hereinafter, it will be referred to as “SMART SMTP protocol) instead SMTP protocol. However, the transfer protocol is not limited to the aforementioned protocol, and the email forwarding request information may be transmitted according to any other protocol. The email forwarding apparatus 120 that has received the email forwarding request information according to the SMART SMTP protocol may determine whether the received information relates to the email forwarding request based on the FWD_File instruction information that is contained in the email forwarding request information. If the email forwarding request is determined based on the FWD_File instruction information, the email forwarding apparatus 120 may determine whether the email forwarding request information includes the access information associated with the attachment file, and transmit a forwarding email that includes the attachment file associated with the access information and/or the remade text information to the receiver email providing apparatus 140.

In response, the receiver email providing apparatus 140 may check whether the received forwarding email includes the attachment file, and if there is the attachment file, store the attachment file, and transmit email receipt notification that includes the access information associated with the attachment file and the remade text information to the receiver terminal device 150. In contrast, if there is no attachment file in the received email, the receiver email providing apparatus 140 may transmit email receipt notification including the remade text information that has been contained in the received forwarding email to the receiver terminal device 150. Then, the receiver terminal device 150 may output to a display the access information and/or the remade text information which have been included in the email receipt notification received from the receiver email providing apparatus 140, and in response to a receiver's request, may receive the attachment file stored in the receiver email providing apparatus 140 and store or output it to the display.

However, the aspect is not limited thereto, and when the forwarding email having the attachment file and the remade text information is received from the email forwarding apparatus 120, the receiver email providing apparatus 140 may transmit email receipt notification that includes the attachment file and the remade text information to the receiver terminal device 150.

As such, in the example illustrated in FIG. 1, when the mobile communication terminal device 130 that has received the original email having the attachment file attached forwards the original email to the receiver email providing apparatus 140 that is connected to the receiver terminal device 150, the mobile communication terminal device 130 is allowed to forward the email to the receiver email providing apparatus 140 without downloading or uploading the attachment file stored in the email forwarding apparatus 120, and thus unnecessary data transfer can be minimized, resulting in an increase of the efficiency of mobile communication and a reduction in line-use fees.

Hereinafter, the configuration of the aforementioned email forwarding apparatus 120 and a method for the email forwarding apparatus 120 to forward an email will now be described.

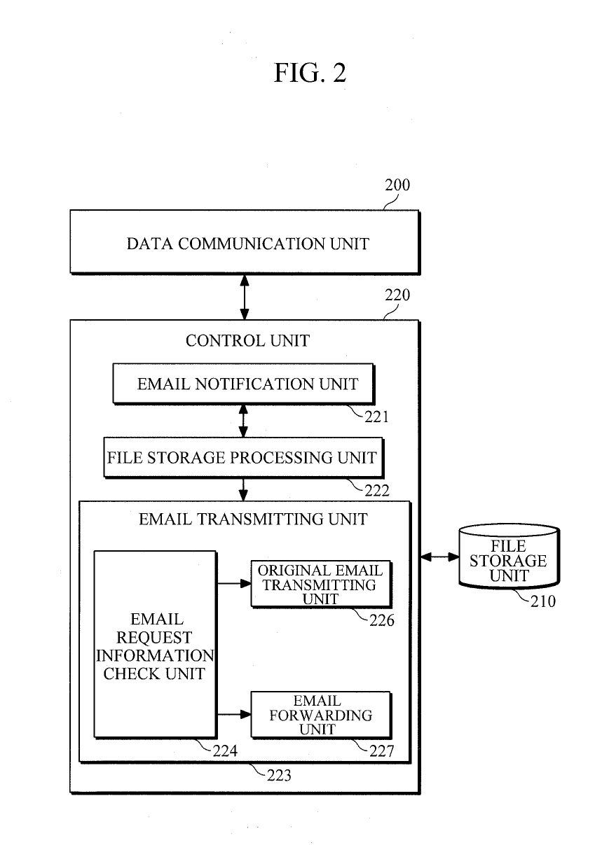

FIG. 2 illustrates a diagram of an example of an email forwarding apparatus.

As shown in FIG. 2, the email forwarding apparatus may include a data communication unit 200, a file storage unit 210, and a control unit 220. The data communication unit 200 may transmit and receive email-related information to and from the transmitter email providing apparatus 110 or the mobile communication terminal device 130, and the file storage unit 210 may store an attachment file including in an original email that has been received from the transmitter email providing apparatus 110. The control unit 220 may transmit an email containing text information or an email containing access information associated with the attachment file stored in the file storage unit 210 and text information included in the original email to the mobile communication terminal device 130. The control unit 220 may transmit a forwarding email that includes remade text information or that includes the attachment file stored in the file storage unit 210 and the remade text information to the receiver email providing apparatus in response to an email forwarding request from the mobile communication terminal device 130 that has received the original email.

The control unit 220 may include an email notification unit 221, a file storage processing unit 222, and an email transmitting unit 223. The email notification unit 221 may transmit email receipt notification to the mobile communication terminal device 130 through the data communication unit 200 in an effort to inform of the receipt of the original email from the transmitter email providing unit 110. For example, when the original email is received from the transmitter email providing apparatus 110 through the data communication unit 200, the email notification unit 221 may check whether the received original email has a file attached. If there is an attachment file, the email notification unit 221 may transmit to the mobile communication terminal device 130 the email receipt notification that includes the access information associated with the stored attachment file and text information contained in the original email. In contrast, if there is no attachment file, the email notification unit 221 may transmit email receipt notification that includes the text information contained in the original email.

If the email notification unit 221 notifies that the original email has the attachment file, the file storage processing unit 222 may store the attachment file in the file storage unit 210. In response to email request information from the mobile communication terminal device 130 that has received the email receipt notification from the email notification unit 221, the email transmitting unit 223 may analyze the received email request information and transmit the email to the mobile communication terminal apparatus 130, or forward the email to the receiver email providing apparatus.

The email transmitting unit 223 may include an email request information check unit 224, an original email transmitting unit 226, and an email forwarding unit 227. The email request information check unit 224 may check whether the email request information received from the mobile communication terminal device 130 is email receipt request information or email forwarding request information. For example, the email request information check unit 224 may check whether the email request information received from the mobile communication terminal device 130 includes FWD_file instruction information for email forwarding.

If the FWD_file instruction information is not included in the email request information, the original email transmitting unit 226 may acquire the attachment file associated with the access information from the file storage unit 210 according to the access information contained in the email request information. Thereafter, the original email transmitting unit 226 may transmit the acquired attachment file to the mobile communication terminal device 130. Thus, the mobile communication terminal device 130 is enabled to download the attachment file from the file storage unit 210 and store or output the attachment file to a display.

In contrast, if it is determined by the email request information check unit 224 that the FWD_file instruction information is included in the email request information, the email forwarding unit 227 may determine that the email request information is email forwarding request information. In this case, the email forwarding request information includes the FWD_file instruction information, remade text information, and/or access information associated with the attachment file. When it is determined that the email request information is email forwarding request information, the email forwarding unit 227 may check whether the email forwarding request information includes the access information associated with the attachment file. If there is the access information, the email forwarding unit 227 may obtain the attachment file associated with the access information from the file storage unit 210. Then, the email forwarding unit 227 may transmit a forwarding email that includes the obtained attachment file and the remade text information that has been included in the email forwarding request information to the receiver email providing apparatus 140. In contrast, if the access information is not included in the email forwarding request information, the email forwarding unit 227 may transmit a forwarding email that includes the remade text information contained in the email forwarding request information to the receiver email providing apparatus 140. Accordingly, the receiver email providing apparatus 140 is allowed to transmit the forwarding email received from the email forwarding apparatus 120 to the receiver terminal device 150 that is connected to the receiver email providing apparatus 140.

Hereinafter, a method for the email forwarding device to forward an email from the transmitter email providing apparatus 110 to the receiver email providing apparatus will be described in detail.

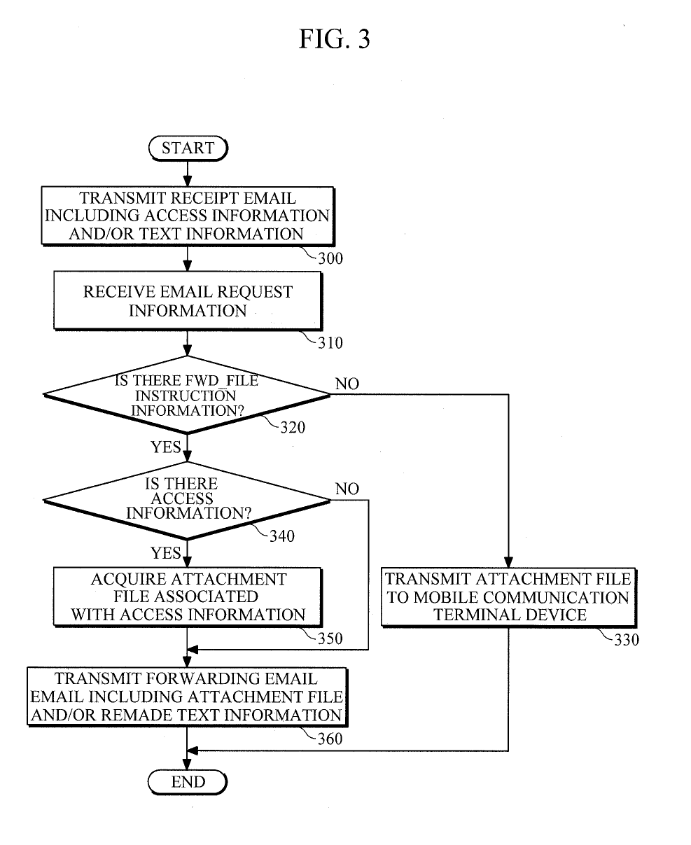

FIG. 3 illustrates a flowchart depicting an example of a method of an email forwarding apparatus to forward an original email received from a transmitter email providing apparatus to a receiver email providing apparatus.

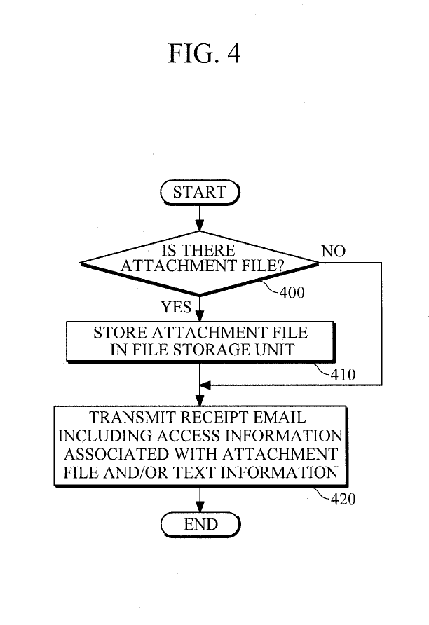

Referring to FIG. 3, in response to the reception of the original email from the transmitter email providing apparatus, the email forwarding apparatus transmits to a mobile communication terminal device a receipt email that includes access information that is associated with an attachment file attached to the received original email and/or text information contained in the original email in operation 300. The email forwarding apparatus may transmit to the mobile communication terminal device the receipt email that includes the access information that stores the attachment file attached to the original email received through operations shown in an example illustrated in FIG. 4 and the text information contained in the original email.

FIG. 4 illustrates a flowchart depicting an example of a method for the email forwarding apparatus to forward a receipt email to the mobile communication terminal device.

Referring to FIG. 4, in response to the reception of the original email from the transmitter email providing apparatus that is connected to the transmitter terminal device, the email forwarding apparatus checks whether the received original email has a file attached in operation 400. If there is the attachment file, the email forwarding apparatus stores the attachment file in a file storage unit in operation 410, and transmits a receipt email that includes access information associated with the stored attachment file and text information contained in the original email to the mobile communication terminal device in operation 420. In contrast, if there is no attachment file, the email forwarding apparatus transmits a receipt email that includes the text information contained in the original email to the mobile communication terminal device.

Referring to FIG. 3 again, the mobile communication terminal device that has received the receipt email that includes the access information and/or the text information contained in the original email transmits email request information to the email forwarding apparatus. The email forwarding apparatus receives the email request information in operation 310. In response to the email request information from the mobile communication terminal device, the email forwarding apparatus checks whether the received email request information includes FWD_file instruction information for email forwarding in operation 320. If the FWD_file instruction information is not included, the email forwarding apparatus uses the access information included in the email request information to acquire the attachment file associated with the access information from the file storage unit, and transmits the acquired attachment file to the mobile communication terminal device in operation 330. In contrast, if the FWD_file instruction information is included, the email forwarding apparatus further checks whether the email request information includes the access information associated with the attachment file in operation 340. If there is the access information, the email forwarding apparatus obtains the attachment file associated with the access information from the storage unit in operation 350. Thereafter, the email forwarding apparatus transmits to the receiver email providing apparatus a forwarding email that includes the obtained attachment file and remade text information contained in the email request information in operation 360. If there is no access information, the email forwarding apparatus transmits to the receiver email providing apparatus a forwarding email that includes remade text information contained in the email request information.

As a result, the receiver email providing apparatus is allowed to transmit the forwarding email received from the email forwarding apparatus to the receiver terminal device connected to the receiver providing apparatus.

As described above, when a mobile communication terminal device that receives an email having an attachment file attached forwards the email to a receiver terminal device, an email forwarding apparatus connected to the mobile communication terminal device may transmit a forwarding email that includes the attachment file to a receiver email providing apparatus connected to the receiver terminal device while the mobile communication terminal apparatus does not need to download or upload the attachment file. Accordingly, unnecessary data transfer between the mobile communication terminal device and a base station is minimized, thereby minimizing channel bandwidth occupancy between the mobile communication terminal device and the base station, and further, reducing line-use fees incurred by data communication.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An email forwarding apparatus for an original email received from a transmitter email providing apparatus to a mobile communication terminal device in response to a request from the transmitter email providing apparatus, the email forwarding apparatus comprising:
a data communication unit configured to transmit and receive information regarding an email to and from the transmitter email providing apparatus or the mobile communication terminal device;
a file storage unit configured to store an attachment file that is attached to the original email; and
a control unit configured to transmit to the mobile communication terminal device an email which includes access information associated with the attachment file stored in the file storage unit and/or text information contained in the original email and transmit to a receiver email providing apparatus a forwarding email which includes the attachment file stored in the file storage unit and/or remade text information.

2. The email forwarding apparatus of claim 1, wherein the control unit is further configured to comprise
a email notification unit configured to transmit to the mobile communication terminal device email receipt notification that contains access information associated with the attachment file and/or the text information contained in the original email according to the presence of the attachment file in the original email received through the data communication unit,
a file storage processing unit configured to store the attachment file attached to the original email in the file storage unit according to the presence of the attachment file in the original email that is determined by the email notification unit, and
an email transmitting unit configured to transmit the attachment file to the mobile communication terminal device or forward the attachment file and/or the remade text information to the receiver email providing unit in response to email request information from the mobile communication terminal device.

3. The email forwarding apparatus of claim 2, wherein the email transmitting unit is further configured to comprise
an email request information check unit configured to check whether the email request information is email receipt request information or email forwarding request information according to the presence of FWD_file instruction information for email forwarding in the email request information, and
an original email transmitting unit configured to determine the email request information as email receipt request information if the email request information check unit determines that there is no FWD_file instruction information in the email request information, acquire from the file storage unit the attachment file associated with access information that is included in the email receipt request information and transmit the acquired attachment file to mobile communication terminal device.

4. The email forwarding apparatus of claim 3, wherein the email forwarding request information includes the FWD_file instruction information for email forwarding, remade text information, and/or access information associated with the attachment file.

5. The email forwarding apparatus of claim 4, wherein the email transmitting unit is further configured to further comprise an email forwarding unit configured to, when it is determined that the FWD_file instruction information is included in the email request information, transmit the forwarding email that includes an attachment file associated with the access information and/or remade text information according to the presence of the access information in the email forwarding request information.

6. A method for an email forwarding apparatus to forward to a receiver email providing apparatus an email related to an original email in response to a request from a mobile communication terminal device, wherein the original email has been received from a transmitter email providing apparatus, the method comprising:
transmitting to the mobile communication terminal device a receipt email that includes access information associated with an attachment file attached to the original email and/or text information contained in the original email;
in response to receiving email request information related to the receipt email from the mobile communication terminal device, checking whether the received email request information is email forwarding request information or not; and
according to the checking result, transmitting the attachment file attached to the original email to the mobile communication terminal or transmitting to the receiver email providing apparatus a forwarding email related to the original email.

7. The method of claim 6, wherein the transmitting of the receipt email to the mobile communication terminal device comprises
checking whether or not the attachment file is attached to the original email,
storing the attachment file attached to the original email in a file storage unit according to the checking result, and
transmitting the receipt email that includes the access information associated with the attachment file stored in the file storage unit and/or the text information to the mobile communication terminal device.

8. The method of claim 6, wherein the checking of whether the received email request information is email forwarding request information comprises checking whether the received email request information includes FWD_file instruction information for email forwarding.

9. The method of claim 8, wherein the transmitting of the attachment file or the forwarding email to the mobile communication terminal device or the receiver email providing apparatus comprises
if it is determined that there is the FWD_file instruction information, further checking whether the email request information includes access information,
if it is determined that there is the access information, acquiring an attachment file associated with the access information from the file storage unit, and
transmitting to the receiver email providing apparatus the forwarding email that includes the acquired attachment file and remade text information contained in the email request information including the FWD_file instruction information.

10. The method of claim 9, wherein the transmitting of the forwarding email to the receiver email providing apparatus comprises to the receiver email providing apparatus the forwarding email that includes remade text information contained in the email request information including the FWD_file instruction information according to the check result.

11. The method of claim 9, wherein the transmitting of the attachment file or the forwarding email to the mobile communication terminal device or the receiver email providing apparatus comprises if there is no FWD_file instruction information in the email request information, transmitting the attachment file associated with the access information from the file storage unit to the mobile communication terminal device based on the access information included in the email request information.
